(19) United States
(12) Patent Application Publication
(10) Pub. No.: US 2012/0015150 A1
(43) Pub. Date: Jan. 19, 2012

(54) COVER GLASS FOR SOLID-STATE IMAGING DEVICE

(75) Inventor: Hidetoshi SUZUKI, Chiyoda-ku (JP)

(73) Assignee: Asahi Glass Company, Limited, Chiyoda-ku (JP)

(21) Appl. No.: 13/178,795

(22) Filed: Jul. 8, 2011

(30) Foreign Application Priority Data
Jul. 13, 2010 (JP) 2010-158707

(51) Int. Cl. B32B 3/00; C03C 3/093

(52) U.S. Cl. 428/156; 501/67

(57) ABSTRACT

To provide a cover glass for a solid-state imaging device, which has a high Young's modulus and a thermal expansion coefficient close to silicon within a wide temperature range and which is useful particularly for a solid-state imaging device produced by CSP.

A cover glass for a solid-state imaging device, which comprises, by mass %, from 56 to 66% of SiO₂, from 9 to 26% of Al₂O₃, from 1 to 11% of B₂O₃, from 0 to 6% of MgO, from 0 to 6% of CaO, from 4 to 13% of ZnO, from 0 to 4% of Li₂O, from 0 to 5% of Na₂O, and from 0 to 6% of K₂O, provided that Li₂O+Na₂O+K₂O is at least 1%, and which has an average thermal expansion coefficient of from 30 to 38×10⁻⁷K⁻¹ within a range of from 30 to 300° C. and a Young's modulus of at least 78 GPa.

### BACKGROUND OF THE INVENTION

1. Field of the Invention

The present invention relates to a cover glass for a solid-state imaging device, which protects solid-state imaging elements and at the same time is used as a light-transmitting window.

2. Discussion of Background

A solid-state imaging device has such a structure that LSI chips as light receiving elements are accommodated in packages; on their light receiving surface, a color separation mosaic filter is overlaid and wire-bonded; and over package openings, a cover glass is sealed by an adhesive. The cover glass used here not only protects LSI chips by air tight sealing with the packages but also efficiently introduces light to the light receiving surface. Accordingly, it is required to have optically homogeneous material properties and high transmittance properties free from internal defects. Further, the glass to be used for such a purpose should be free from cracking or distortion when sealed with the packages. That is, it is necessary to let the thermal expansion coefficients of the glass and the package material match each other. As the package material, a ceramic material such as alumina having an average thermal expansion coefficient of from 60 to 75×10⁻⁷K⁻¹ has been used, and as a cover glass to match it, a borosilicate glass having an average thermal expansion coefficient of from 45 to 75×10⁻⁷K⁻¹ is available.

On the other hand, toward the requirement for size reduction in a solid-state imaging device for e.g. digital cameras, a solid-state imaging device using a production process by chip size package (CSP) is being studied (Patent Document 1). According to this production process, a plurality of solid-state imaging elements constituting light-receiving sections are formed on a silicon wafer; a cover glass wafer made of a transparent material is bonded to the silicon wafer via spacers formed to correspond to the light-receiving sections; and then the cover glass wafer and the silicon wafer are cut into individual pieces thereby to produce solid-state imaging devices in a lump.
Patent Document 1: JP-A-2006-80297

### SUMMARY OF THE INVENTION

Along with the trend in recent years to make digital cameras, mobile phones, etc. thinner, further thinning the solid-state imaging devices themselves is required. However, there are the following problems in an attempt to carry out thinning by the above mentioned production process for solid-state imaging devices by means of the above-mentioned CSP.

In order to make solid-state imaging devices thinner, it is necessary to make the respective thicknesses of the cover glass wafer, the spacer and the silicon wafer thinner. However, if the cover glass wafer or the silicon wafer is made thinner, its rigidity decreases, thus leading to a problem such that it tends to undergo deflection. In the production process by means of CSP, if it is assumed to use the cover glass wafer or the silicon wafer in a large size of e.g. 8 inch size, there will be a deflection of a few mm by its own weight although it may also depend on the wafer thickness, and such deflection becomes more influential as the wafer size increases. Especially, a cover glass wafer is bonded to a silicon wafer after forming spacers, but if the deflection of the cover glass wafer is large, the shape becomes unstable, and it becomes difficult to construct the process for forming spacers. Patent Document 1 exemplifies use of Pyrex (registered trademark) glass as a cover glass wafer. However, as compared with a silicon wafer having Young's modulus of from 100 to 120 GPa, the Pyrex (registered trademark) glass has a Young's modulus as small as 63 GPa and thus has the problem of deflection.

Further, the cover glass wafer is required to be a material having a thermal expansion coefficient which well matches silicon. Therefore, the above-mentioned borosilicate glass having an average thermal expansion coefficient of from 45 to 74×10⁻⁷K⁻¹ which matches alumina packages cannot be used. Whereas, Pyrex (registered trademark) glass is known to show an average thermal expansion coefficient of a value close to silicon, and as mentioned above, it is known to be used for a cover glass wafer. However, the thermal expansion coefficient of the Pyrex (registered trademark) glass itself is different from silicon. That is, when an ordinate represents the thermal expansion and an abscissa represents the temperature, silicon shows a thermal expansion curve which is convex downward, while the Pyrex (registered trademark) glass shows a thermal expansion curve convex upward in a temperature range of at most the transition temperature (about 550° C.). As a result, a solid-state imaging device using the Pyrex (registered trademark) glass as a cover glass, has a problem such that a difference in thermal expansion will result between the silicon and the cover glass by a temperature change. If the solid-state imaging device undergoes warpage, there will be a trouble such that a distortion is formed in the image, which should be avoided as far as possible.

The present invention is to solve the above problems, and it is an object of the present invention to provide a cover glass which is a cover glass for a solid-state imaging device and which has a high Young's modulus of glass and is particularly useful for a solid-state imaging device to be produced by CSP having a thermal expansion coefficient close to silicon within a wide temperature range.

In order to accomplish the above object, the present invention provides a cover glass for a solid-state imaging device, which comprises, by mass %, from 56 to 66% of SiO₂, from 9 to 26% of Al₂O₃, from 1 to 11% of B₂O₃, from 0 to 6% of MgO, from 0 to 6% of CaO, from 4 to 13% of ZnO, from 0 to 4% of Li₂O, from 0 to 5% of Na₂O, and from 0 to 6% of K₂O, provided that Li₂O+Na₂O+K₂O is at least 1%, and which has an average thermal expansion coefficient of from 30 to 38×10⁻⁷K⁻¹ within a range of from 30 to 300° C. and a Young's modulus of at least 78 GPa.

Further, the cover glass for a solid-state imaging device of the present invention is to be bonded to a silicon substrate having a plurality of solid-state imaging elements formed thereon.

Further, the cover glass for a solid-state imaging device of the present invention is to be bonded to the silicon substrate by means of an adhesive.

Further, in the cover glass for a solid-state imaging device of the present invention, recesses are formed at portions corresponding to the plurality of solid-state imaging elements formed on the silicon substrate.

According to the cover glass for a solid-state imaging device of the present invention, the glass has a high Young's modulus and its thermal expansion coefficient is close to silicon within a wide temperature range, whereby it is possible to avoid such a trouble that a solid-state imaging device produced by CSP undergoes warpage by a temperature change.

### BRIEF DESCRIPTION OF THE DRAWINGS

FIG. 1 is a cross sectional view of an embodiment a solid-state imaging device using the cover glass for a solid-state imaging device of the present invention.

FIG. 2 is a cross sectional view of another embodiment of a solid-state imaging device using the cover glass for a solid-state imaging device of the present invention.

FIG. 3 is a plan view in an embodiment of the cover glass for a solid-state imaging device of the present invention.

### DETAILED DESCRIPTION OF THE PREFERRED EMBODIMENTS

The reasons for the above definitions of the contents (represented by mass %) of the respective components constituting the cover glass of the present invention will be described as follows.

SiO₂ is the main component to form the network structure of glass. If it is less than 56%, the weather resistance of glass tends to be poor, and if it exceeds 66%, the melting property tends to be low, whereby vitrification tends to be difficult. It is preferably within a range of from 59 to 63%.

Al₂O₃ is a component to improve the Young's modulus and weather resistance of glass. If it is less than 9%, such effects tend to be hardly obtainable, and if it exceeds 26%, devitrification tends to be strong, whereby vitrification tends to be difficult. It is preferably within a range of from 12 to 20%.

B₂O₃ is a component to reinforce the glass structure and to facilitate vitrification. If it is less than 1%, such effects tend to be hardly obtainable, and if it exceeds 11%, the weather-resistance tends to deteriorate. It is preferably within a range of from 5 to 10%.

MgO or CaO is a component to improve the weather resistance. If it exceeds 6%, such effects tend to be hardly obtainable. It is preferably within a range of at most 4%.

ZnO is a component to improve the weather resistance. If it is less than 4%, such an effect tends to be hardly obtainable, and if it exceeds 13%, devitrification tends to be intensified. It is preferably within a range of from 7 to 10%.

Li₂O, Na₂O or K₂O is a component to improve the melting property and to mainly adjust the expansion coefficient. If Li₂O exceeds 4%, the desired expansion coefficient tends to be hardly obtainable. Its preferred range is at most 2.5%. If Na₂O exceeds 5%, the desired expansion coefficient tends to be hardly obtainable.

Its preferred range is at most 3.0%. If K₂O exceeds 6%, the desired expansion coefficient tends to be hardly obtainable. Its preferred range is at most 3.5%. However, if Li₂O+Na₂O+K₂O is less than 1%, the desired expansion coefficient tends to be hardly obtainable. The preferred range is at least 2%. The cover glass for a solid-state imaging device of the present invention has an average thermal expansion coefficient of from 30 to 38×10⁻⁷K⁻¹ within a range of from 30 to 300° C., whereby in a solid-state imaging device to be produced by using the process for CSP, the thermal expansion coefficients of the silicon wafer and the cover glass wafer to be bonded, will agree to each other within a wide temperature range, and it is thereby possible to avoid such a trouble that the solid-state imaging device undergoes warpage by a temperature change.

The cover glass for a solid-state imaging device of the present invention has a Young's modulus of at least 78 GPa, whereby a deflection under its own weight is little, and the shape of glass is stable, and accordingly, at the time of producing a solid-state imaging device by using the process for CSP, a high dimensional precision can be secured, for example, in the formation of spacers.

The cover glass for a solid-state imaging device of the present invention can be prepared as follows. Firstly, raw materials are weighed and mixed so that glass to be obtained will be in the above described compositional range. Such a raw material mixture is put in a platinum crucible and heated and melted in an electric furnace at a temperature of from 1,550 to 1,650° C. After sufficient stirring and refining, the melt is cast in a mold and annealed, followed by cutting and polishing to obtain a flat plate form cover glass. Further, as the case requires, this flat plate form cover glass is subjected to contour shaping. Here, as a forming method to make the cover glass into a flat plate form, a float process or a known method such as a downdraw method or a rollout method may be used.

Now, embodiments of the cover glass for a solid-state imaging device of the present invention will be described. FIG. 1 is a cross sectional view of an embodiment wherein the cover glass for a solid-state imaging device of the present invention is bonded to a silicon substrate having a plurality of solid-state imaging elements formed thereon.

In this embodiment, firstly, spacers 4 are formed on a cover glass 1 for a solid-state imaging device. The spacers 4 are in a frame-form surrounding solid-state imaging elements 3, and a plurality of such spacers are formed on the cover glass for a solid-state imaging device at positions corresponding to solid-state imaging elements. The spacers 4 are preferably made of an inorganic material or organic material having a thermal expansion coefficient close to the silicon substrate 2 and the cover glass 1 for a solid-state imaging device. For example, on the cover glass 1 for a solid-state imaging device, a silicon wafer is bonded by an adhesive, and patterning of a resist by photolithography technique or a dry etching technique is applied to the silicon wafer to remove unnecessary portions, followed by cleaning to remove the resist and the adhesive to form spacers 4 in a frame form. Otherwise, spacers 4 may be formed by means of a resist, a photosensitive adhesive or an adhesive sheet.

Then, the cover glass 1 for a solid-state imaging device having the spacers 4 formed thereon and a silicon substrate (silicon wafer) 2 having solid-state imaging elements 3 formed thereon, are bonded. An adhesive 5 is employed for the bonding of the spacers 4 and the silicon substrate 2. As the adhesive 5, an epoxy type or silicon type resin is, for example, suitable, but any adhesive may be employed so long as the desired adhesive strength is obtainable, and it is possible to form a thin adhesive layer to obtain high reliability to prevent penetration of e.g. moisture. For example, a heat-curable adhesive or an ultraviolet-curable adhesive may be used. Further, in a case where solid-state imaging elements 3 are formed on the silicon substrate 2, if a high voltage is applied or a high temperature state is created at the time of bonding the glass and the silicon substrate, the solid-state imaging elements (3) are likely to be broken, and therefore, anodic bonding should not be used for the bonding of the glass and the silicon substrate.

And, one having the cover glass 1 for a solid-state imaging device and the silicon substrate 2 integrated is cut into individual pieces to obtain solid-state imaging devices 10.

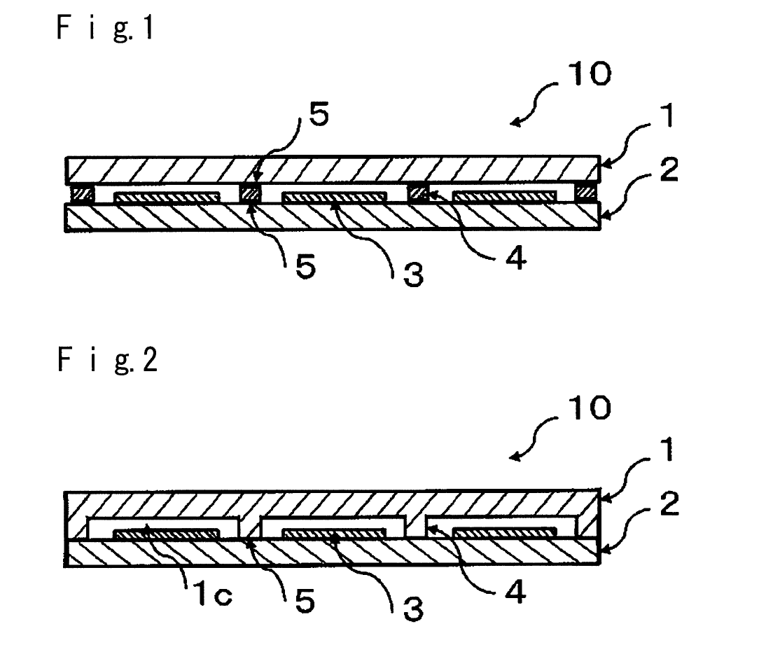

Another embodiment of the cover glass for a solid-state imaging device of the present invention will be described with reference to FIG. 2. FIG. 2 is a cross sectional view of such another embodiment wherein a cover glass 1 for a solid-state imaging device of the present invention is bonded to a silicon substrate 2 having a plurality of solid-state imaging elements 3 formed thereon. Such another embodiment is different from the embodiment shown in FIG. 1 in that spacers 4 are integrally formed with the cover glass 1 for a solid-state imaging device, and accordingly, only the different points will be described.

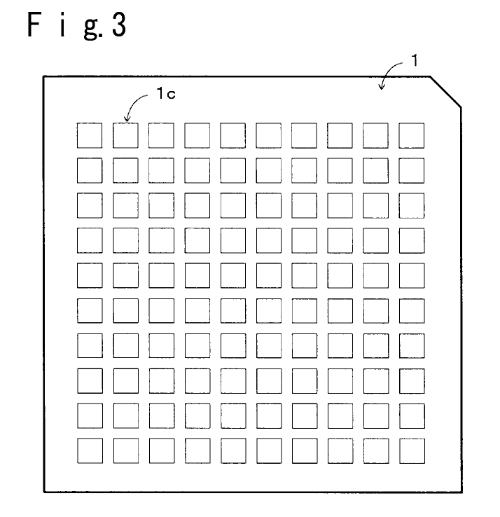

In this embodiment, firstly, recesses 1c are formed on the cover glass 1 for a solid-state imaging device. Recesses 1c are ones formed in a plurality on the cover glass 1 for a solid-state imaging device at positions corresponding to the solid-state imaging elements 3, and they are formed by applying an etching process to a flat plate-form glass cover 1 for a solid-state imaging device. As such an etching process, it is particularly preferred to employ wet etching. When recesses are formed on the flat plate-form material by wet etching, the processed bottom portions of recesses, which become a light-transmitting plane to the solid-state imaging elements, have a high planarity and have a surface state equal to one optically polished. As a specific forming method, a resist is patterned by a photolithography technique, and then unnecessary portions are removed by wet etching so that the portions to constitute spacers 4 will remain on the flat plate-form cover glass 1 for a solid-state imaging device thereby to form recesses 1c. A plan view of the obtained cover glass 1 for a solid-state imaging device having spacers 4 integrally formed, is shown in FIG. 3.

Then, the cover glass 1 for a solid-state imaging device having spacers 4 integrally formed and the silicon substrate (silicon wafer) 2 having solid-state imaging elements 3 formed thereon are bonded by using an adhesive 5.

And, one having the cover glass for a solid-state imaging device and the silicon substrate integrated is cut into individual pieces to obtain solid-state imaging devices 10.

Here, in the present invention, “bonded to the silicon substrate 3 having a plurality of solid-state imaging elements 3 formed thereon” includes not only one having the above cover glass and spacers integrally formed, but also a structure wherein the cover glass and the silicon substrate are bonded via spacers made of a material different from the cover glass.

### EXAMPLES

Examples of the present invention and Comparative Examples are shown in Tables 1 and 2. In the present specification, Examples 1 to 16 represent Examples of the present invention, and Examples 17 to 19 represent Comparative Examples. In the Tables, glass compositions are shown by mass %. Further, the comparative example glass in Example 19 is Pyrex (registered trademark) glass.

For such glass, raw materials were weighed and mixed to have a composition shown in the Tables, and the mixture was put into a platinum crucible having an internal capacity of about 300 cc and melted, refined and stirred at from 1,550 to 1,650° C. for from 1 to 3 hours and then cast into a mold of a prescribed size preliminarily heated to from about 300 to 500° C. and then annealed at about 1° C./min to obtain a sample. The glass was visually observed at the time of preparation of the sample to confirm that no bubbles or striae were observed. The average thermal expansion coefficient and the Young's modulus were measured by the following methods.

For the average thermal expansion coefficient, the obtained glass was processed into a rod, and its average thermal expansion coefficient was measured by a thermal expansion method by means of a thermal analyzer (apparatus name: TMA8310, manufactured by Rigaku Corporation) at a temperature raising rate of 5° C./min.

For the Young's modulus, a test piece having a length of 90 mm, a width of 20 mm and a thickness of 2 mm was prepared, and its Young's modulus was measured in accordance with JIS R1602 Dynamic Elastic Modulus Test Method (1) Flexural Vibration Method in Elastic Modulus Test Method for Fine Ceramics.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 57.0 | 65.9 | 60.8 | 63.4 | 59.3 | 63.7 | 65.7 | 65.0 | 62.8 |
| Al₂O₃ | 20.8 | 9.2 | 15.5 | 13.1 | 12.7 | 16.4 | 15.3 | 12.8 | 12.0 |
| B₂O₃ | 8.5 | 7.7 | 6.0 | 10.0 | 9.1 | 8.4 | 8.7 | 10.9 | 10.1 |
| MgO | | 4.1 | 4.3 | 1.5 | 5.0 | | 1.0 | | 4.0 |
| CaO | 3.2 | | 2.7 | | | 5.0 | | 0.9 | 0.9 |
| ZnO | 8.3 | 10.1 | 7.9 | 9.8 | 12.0 | 5.0 | 5.6 | 5.9 | 5.2 |
| Li₂O | 2.2 | | | 2.2 | | 1.5 | 3.7 | | |
| Na₂O | | 3.0 | 2.8 | | 1.9 | | | 4.5 | |
| K₂O | | | | | | | | | 5.0 |
| BaO | | | | | | | | | |
| Cl | | | | | | | | | |
| F | | | | | | | | | |
| α(×10⁻⁷K⁻¹) | 33 | 35 | 38 | 32 | 32 | 31 | 38 | 37 | 38 |
| Young's modulus (GPa) | 81 | 78 | 81 | 79 | 80 | 80 | 81 | 80 | 80 |

TABLE 2

| | Ex. | Ex. | Ex. | Ex. | Ex. | Ex. | Ex. | Ex. | Ex. | Ex. |
|---|---|---|---|---|---|---|---|---|---|---|
| | 10 | 11 | 12 | 13 | 14 | 15 | 16 | 17 | 18 | 19 |
| SiO₂ | 58.1 | 61.5 | 60.9 | 56.5 | 62.7 | 60.0 | 57.8 | 64.9 | 65.6 | 80.9 |
| Al₂O₃ | 18.6 | 11.1 | 14.5 | 25.6 | 18.8 | 22.7 | 24.0 | 5.0 | 2.0 | 2.3 |
| B₂O₃ | 6.5 | 10.9 | 9.7 | 3.3 | 1.4 | 3.8 | 8.4 | 19.0 | 18.5 | 12.6 |
| MgO | 3.3 | 2.2 | 3.6 | 4.0 | 1.0 | | 1.2 | | | |
| CaO | | 2.1 | | | 2.9 | 4.0 | | 2.6 | | |
| ZnO | 11.9 | 9.9 | 8.7 | 8.3 | 10.6 | 6.4 | 6.1 | 2.0 | 2.7 | |
| Li₂O | 1.6 | 0.5 | | 2.3 | 0.5 | 0.7 | 2.5 | 0.6 | 0.1 | |
| Na₂O | | 1.8 | 1.6 | | 2.1 | | | 2.3 | 6.4 | 4.0 |
| K₂O | | | 1.0 | | | 2.4 | | 3.5 | 2.0 | |
| BaO | | | | | | | | | 3.5 | |
| Cl | | | | | | | | 0.1 | | |
| F | | | | | | | | | 0.2 | |
| α(×10⁻⁷K⁻¹) | 30 | 35 | 33 | 32 | 36 | 35 | 31 | 51 | 60 | 33 |
| Young's | 80 | 80 | 81 | 86 | 81 | 84 | 86 | 78 | 73 | 63 |
| modulus (GPa) | | | | | | | | | | |

As is evident from the results in Tables 1 and 2, glasses in Examples have average thermal expansion coefficients of from 30 to 38×10⁻⁷K⁻¹, which are close to the thermal expansion coefficient of silicon. Further, each of the glasses in Examples has a Young's modulus of 78 GPa, whereby deflection under its own weight is little, and the shape is stable, and for example, at the time of forming spacers on the cover glass, there will be no problem with respect to e.g. the dimensional precision.

As described in the foregoing, the glass of the present invention has an average thermal expansion coefficient of from 30 to 38×10⁻⁷K⁻¹, whereby in a solid-state imaging device to be bonded to silicon, warpage or the like due to a temperature change will not result. Further, its Young's modulus is at least 78 GPa, whereby to deflection under its own weight is little, and it is very useful as a cover glass for a solid-state imaging device to be produced by using a production process for CSP.

The entire disclosure of Japanese Patent Application No. 2010-158707 filed on Jul. 13, 2010 including specification, claims, drawings and summary is incorporated herein by reference in its entirety.

What is claimed is:

1. A cover glass for a solid-state imaging device, which comprises, by mass %, from 56 to 66% of SiO₂, from 9 to 26% of Al₂O₃, from 1 to 11% of B₂O₃, from 0 to 6% of MgO, from 0 to 6% of CaO, from 4 to 13% of ZnO, from 0 to 4% of Li₂O, from 0 to 5% of Na₂O, and from 0 to 6% of K₂O, provided that Li₂O+Na₂O+K₂O is at least 1%, and which has an average thermal expansion coefficient of from 30 to 38×10⁻⁷K⁻¹ within a range of from 30 to 300° C. and a Young's modulus of at least 78 GPa.

2. The cover glass for a solid-state imaging device according to claim 1, which is to be bonded to a silicon substrate having a plurality of solid-state imaging elements formed thereon.

3. The cover glass for a solid-state imaging device according to claim 2, which is to be bonded to the silicon substrate by means of an adhesive.

4. The cover glass for a solid-state imaging device according to claim 2, wherein recesses are formed at portions corresponding to the plurality of solid-state imaging elements formed on the silicon substrate.

5. The cover glass for a solid-state imaging device according to claim 3, wherein recesses are formed at portions corresponding to the plurality of solid-state imaging elements formed on the silicon substrate.
